(19) United States
(12) Patent Application Publication
(10) Pub. No.: US 2014/0152632 A1
(43) Pub. Date: Jun. 5, 2014

(54) Solar Cell Ambient Light Sensors For Electronic Devices

(71) Applicant: APPLE INC., Cupertino, CA (US)

(72) Inventors: Anna-Katrina Shedletsky, Mountain View, CA (US); Erik G. de Jong, San Francisco, CA (US); Fletcher R. Rothkopf, Los Altos, CA (US); Anthony S. Montevirgen, San Francisco, CA (US)

(73) Assignee: Apple Inc., Cupertino, CA (US)

(21) Appl. No.: 13/693,249

(22) Filed: Dec. 4, 2012

(51) Int. Cl. G01J 1/42; G09G 5/10

(52) U.S. Cl. CPC G01J 1/4204; G09G 5/10; G09G 2360/144
USPC 345/207; 250/214 AL; 250/208.2

(57) ABSTRACT

An electronic device is provided with a display and a solar cell ambient light sensor that receives light through a portion of the display. The solar cell ambient light sensor may include one or more thin-film photovoltaic cells. A voltage that accumulates within the thin-film photovoltaic cell in response to ambient light is sampled and converted into ambient light data. The device includes control circuitry that modifies the intensity of display light generated by the display based on the ambient light data from the photovoltaic cell. The solar cell ambient light sensor is attached to a transparent cover layer, a color filter layer, or any other layer of the display. When the accumulated voltage is not being sampled for ambient light measurements, the voltage may be used to provide charge to a battery in the device.

### BACKGROUND

This relates generally to electronic devices and, more particularly, to electronic devices with displays and light sensors.

Electronic devices often include displays. For example, cellular telephones and portable computers often include displays for presenting information to a user.

Electronic devices also often include light sensors. For example, an electronic device may include an ambient light sensor that senses the amount of light in the environment surrounding the device. The brightness of display images generated by the display is sometimes adjusted based on the amount of ambient light. For example, in bright sunlight, the display brightness may be increased and in a dark room, the display brightness can be decreased.

In a typical device, a light sensor that is formed from a chip package having a photodiode is laterally displaced from an active display region of the display along a front face of the device. Additional space is therefore provided in common devices at the top, bottom, or side of the active display area to accommodate the light sensor.

This type of additional space for a common light sensor package can result in an undesirable increase in the size and thickness of the device.

It would therefore be desirable to be able to provide improved electronic devices with light sensors and displays.

### SUMMARY

An electronic device is provided with a display such as an organic light-emitting diode display mounted in an electronic device housing. The electronic device is also provided with one or more light sensors.

The display includes multiple display layers such as one or more light-generating layers, a touch-sensitive layer, and a cover layer. The cover layer may, for example, be a layer of rigid transparent material such as glass or transparent plastic.

The light sensor is formed from one or more solar cells such as a thin-film photovoltaic solar cell. The thin-film solar cell light sensor is configured as a solar cell ambient light sensor that is coupled to circuitry in the device. The circuitry includes a printed circuit board and, if desired, additional control circuitry for operating device components such as the display and the solar cell ambient light sensor.

During operation, a voltage is generated on the thin film solar cells in response to ambient light that falls on the thin film solar cells. The voltage is read (sampled) by the control circuitry and an ambient light intensity is determined based on the sampled voltage.

The solar cell ambient light sensor is mounted to a layer of the display such as a display cover layer, a display color filter layer, or an innermost layer of the display. In one suitable example, the solar cell ambient light sensor is mounted to an innermost layer of the display and receives the ambient light through substantially all of the layers of the display.

In configurations in which the solar cell ambient light sensor is mounted to a display cover layer or a display color filter layer, the solar cell ambient light sensor may receive light through a partially opaque masking layer that is formed on the cover layer or the color filter layer. The partially opaque masking layer may block a portion of the light that falls on the masking layer and may transmit another portion of the light. As examples, the partially opaque masking layer may block a fraction of all wavelengths of light or may block some wavelengths of light while passing other wavelengths of light.

The device may be provided with multiple solar cell ambient light sensors. Each solar cell ambient light sensor may receive light having a common set of wavelengths or some solar cell ambient light sensors may be configured to detect light having a first range of wavelengths and other solar cell ambient light sensors may be configured to detect light having a different range of wavelengths. The circuitry may adjust the brightness of the display based on the detected light from the solar cell ambient light sensors.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with a solar cell ambient light sensor in accordance with an embodiment.

FIG. 2 is a perspective view of an illustrative electronic device such as a handheld electronic device with a solar cell ambient light sensor in accordance with an embodiment.

FIG. 3 is a perspective view of an illustrative electronic device such as a tablet computer with a solar cell ambient light sensor in accordance with an embodiment.

FIG. 4 is a perspective view of an illustrative electronic device such as a computer display with a solar cell ambient light sensor in accordance with an embodiment.

FIG. 5 is a schematic diagram of an illustrative electronic device with a solar cell ambient light sensor in accordance with an embodiment.

FIG. 6 is a cross-sectional side view of a portion of an illustrative electronic device having a solar cell ambient light sensor mounted behind at least a portion of a display in accordance with an embodiment.

FIG. 7 is a diagram of an illustrative set of display layers that may be used to form a display in accordance with an embodiment.

FIG. 8 is a cross-sectional view of a portion of an illustrative electronic device having a solar cell ambient light sensor attached to an outer layer of a display in accordance with an embodiment.

FIG. 9 is a cross-sectional view of a portion of an illustrative electronic device having a solar cell ambient light sensor attached to a color filter layer of a display in accordance with an embodiment.

FIG. 10 is a cross-sectional end view of an illustrative electronic device having a solar cell ambient light sensor attached to an interior surface of a display in accordance with an embodiment.

FIG. 11 is a cross-sectional view of a portion of an illustrative electronic device of the type shown in FIG. 10 showing how a display support structure may be provided with an opening that accommodates a flexible circuit connector for the light sensor in accordance with an embodiment.

FIG. 12 is a cross-sectional view of a portion of an illustrative electronic device having a solar cell ambient light sensor attached to an interior surface of a bottom emission organic light-emitting diode display in accordance with an embodiment.

FIG. 13 is a cross-sectional view of a portion of an illustrative electronic device having a solar cell ambient light sensor attached to an interior surface of a top emission organic light-emitting diode display in accordance with an embodiment.

FIG. 14 is a cross-sectional view of a portion of an illustrative electronic device having a solar cell ambient light sensor attached to an interior surface of a liquid crystal display in accordance with an embodiment.

FIG. 15 is a cross-sectional view of a portion of an illustrative electronic device having a solar cell ambient light sensor attached to a display layer that is coated with masking materials in accordance with an embodiment.

### DETAILED DESCRIPTION

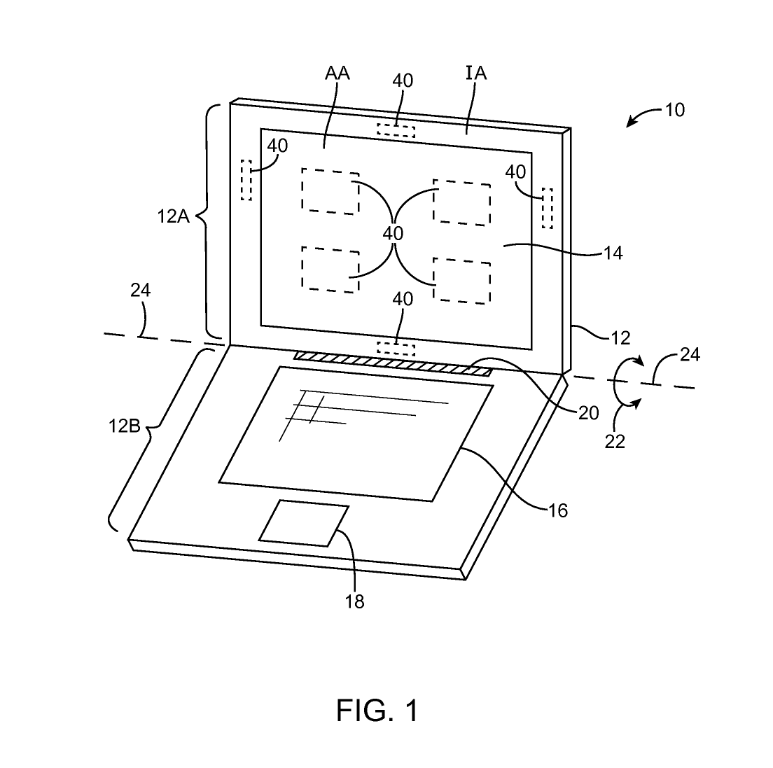

Electronic devices may be provided with displays and solar cell ambient light sensors. Illustrative electronic devices that have displays and solar cell ambient light sensors are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 to allow upper housing 12A to rotate in directions 22 about rotational axis 24 relative to lower housing 12B. Display 14 is mounted in upper housing 12A. Upper housing 12A, which may sometimes referred to as a display housing or lid, is placed in a closed position by rotating upper housing 12A towards lower housing 12B about rotational axis 24. Light sensors such as solar cell ambient light sensors 40 are mounted behind a portion of display 14. Light sensors 40 may be ambient light sensors, proximity sensors, or other light sensors that sense the amount of light falling on the light sensor using photovoltaic technology such as thin-film solar cell technology.

Light sensors 40 may be formed from thin-film photovoltaic cells that include a semiconductor substrate such as an amorphous silicon substrate, a cadmium telluride substrate, or a copper indium gallium deselenide substrate on which a voltage is generated in response to incident light. Light sensors 40 may include additional layers of material such as a glass layer, a metal foil layer, a zinc oxide layer, a carbon paste layer, a tin oxide layer or other oxide layer, a cadmium stannate layer, a cadmium sulfide layer, or other layers of material. Circuitry in the device such as control circuitry that is coupled to the light sensor samples the voltage and determines, for example, an ambient light intensity from the sampled voltage.

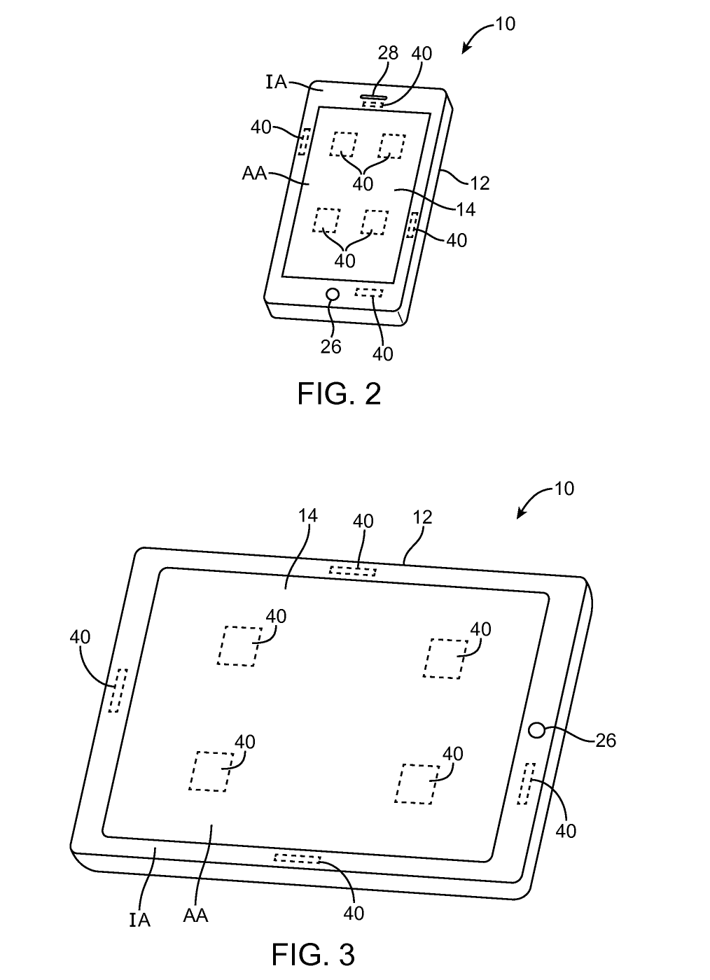

FIG. 2 shows an illustrative configuration for electronic device 10 in which device 10 is implemented as a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer such as a rigid transparent layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an external layer with an opening to accommodate button 26.

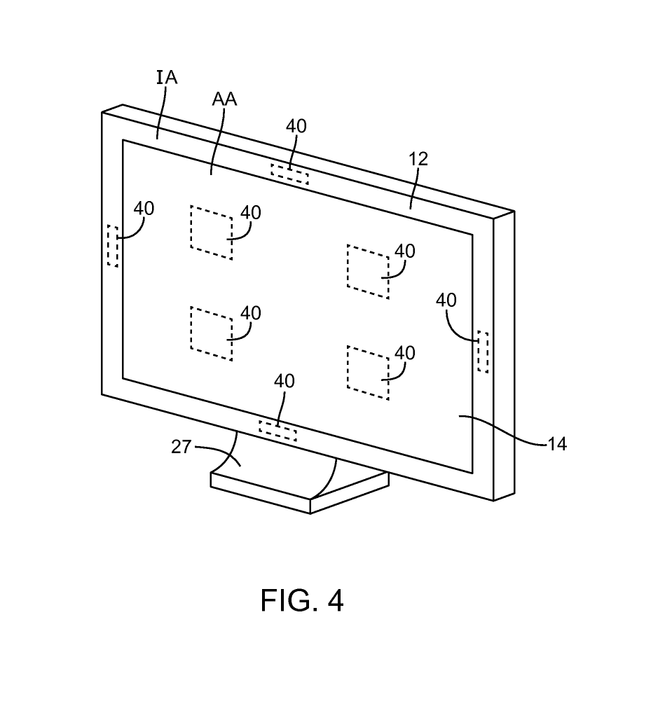

FIG. 4 shows an illustrative configuration for electronic device 10 in which device 10 is a computer display or a computer that has been integrated into a computer display. With this type of arrangement, housing 12 for device 10 is mounted on a support structure such as stand 27. Display 14 is mounted on a front face of housing 12.

In some configurations, peripheral portions of display 14 are provided with a partially or completely opaque masking layer. As shown in FIGS. 1, 2, 3, and 4, display 14 may be characterized by a central active region such as active region AA in which an array of display pixels is used in displaying information for a user. An inactive region such as inactive border region IA surrounds active region AA. In the examples of FIGS. 1, 2, 3, and 4, active region AA has a rectangular shape. Inactive region IA has a rectangular ring shape that surrounds active region AA (as an example). Portions of display 14 in inactive region IA may be covered with a partially opaque masking material such as a layer of black ink (e.g., a polymer filled with carbon black) or a layer of partially opaque metal. The masking layer helps hide components in the interior of device 10 in inactive region IA from view by a user.

In the examples of FIGS. 1, 2, 3, and 4, four solar cell ambient light sensors 40 are mounted behind portions of display 14 in active area AA and additional solar cell ambient light sensors 40 are mounted behind portions of display 14 in inactive area IA. However, this is merely illustrative. If desired, device 10 may include more than four light sensors 40 in active area AA, less than four light sensors 40 in active area AA, more than four light sensors 40 in inactive area IA, less than four light sensors 40 in inactive area IA, a light sensor 40 that extends behind substantially all of active area AA, behind substantially all of inactive area IA, or behind substantially all of active area AA and inactive area AA.

A light sensor such as light sensors 40 that is located in inactive area IA is attached to a display cover layer or a display color filter layer (as examples). Portions of the display cover layer and/or the display color filter layer include a partially opaque masking layer that hides internal components such as the light sensor from view by a user.

Light sensors 40 in inactive area IA receive ambient light through the display cover layer and/or the display color filter layer, and the partially opaque masking layer. Light having a given range of wavelengths passes through the masking layer (e.g., an ink filter layer) onto the light sensors. However, this is merely illustrative. If desired, the masking layer may allow a fraction of light of all wavelengths to pass through the masking layer.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, is formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch-sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Displays for device 10 may, in general, include image pixels formed from light-emitting diodes (LEDs), organic LEDs (OLEDs), plasma cells, electrowetting pixels, electrophoretic pixels, liquid crystal display (LCD) components, or other suitable image pixel structures. In some situations, it may be desirable to use OLED components to form display 14, so configurations for display 14 in which display 14 is an organic light-emitting diode display are sometimes described herein as an example. Other types of display technology may be used in device 10, if desired.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

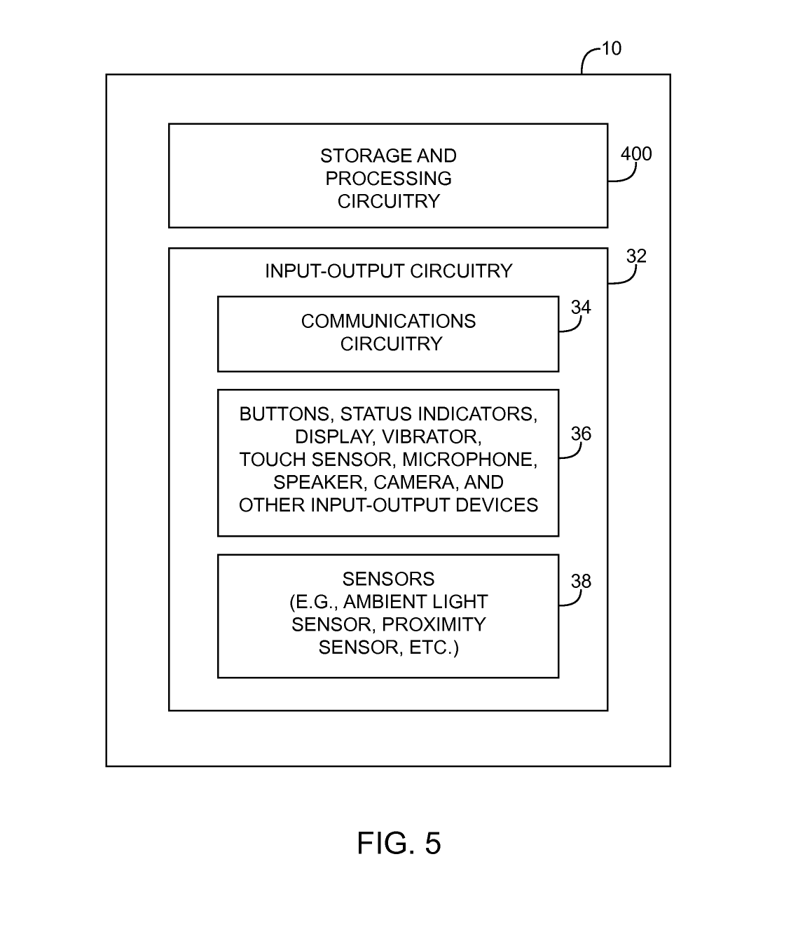

A schematic diagram of device 10 is shown in FIG. 5. As shown in FIG. 5, electronic device 10 includes control circuitry such as storage and processing circuitry 400. Storage and processing circuitry 400 includes one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 400 is used in controlling the operation of device 10. The processing circuitry may be based on a processor such as a microprocessor and other integrated circuits.

With one suitable arrangement, storage and processing circuitry 400 is used to run software on device 10 such as internet browsing applications, email applications, media playback applications, operating system functions, software for capturing and processing images, software for implementing functions associated with gathering and processing sensor data, etc.

Input-output circuitry 32 is used to allow data to be supplied to device 10 and to allow data to be provided from device 10 to external devices.

Input-output circuitry 32 can include wired and wireless communications circuitry 34. Communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Input-output circuitry 32 of FIG. 5 includes input-output devices 36 such as buttons, joysticks, click wheels, scrolling wheels, a touch screen such as display 14, other touch sensors such as track pads or touch-sensor-based buttons, vibrators, audio components such as microphones and speakers, image capture devices such as a camera module having an image sensor and a corresponding lens system, keyboards, status-indicator lights, tone generators, key pads, and other equipment for gathering input from a user or other external source and/or generating output for a user.

Sensors 38 of FIG. 5 include a light sensor such as a solar cell ambient light sensor for gathering information on ambient light levels. The ambient light sensor includes one or more semiconductor detectors (e.g., thin amorphous silicon based light detection circuitry, cadmium telluride light sensor circuitry, or copper indium gallium deselenide light detection circuitry) or other light detection circuitry. Sensors 38 also include other light sensor components such as proximity sensor components. Proximity sensor components in device 10 can include capacitive proximity sensor components, infrared-light-based proximity sensor components, proximity sensor components based on acoustic signaling schemes, solar cell light sensor technology, or other proximity sensor equipment. Sensors 38 may also include a pressure sensor, a temperature sensor, an accelerometer, a gyroscope, and other circuitry for making measurements of the environment surrounding device 10.

It can be challenging to mount electrical components such as the components of FIG. 5 within an electronic device. To facilitate mounting of components in housing 12 of device 10, sensors 38 may be include one or more ambient light sensors that are formed from thin (photovoltaic) solar cells that receive ambient light through a portion of the device display. For example, device 10 may include a solar cell ambient light sensor (sometimes referred to herein as a photovoltaic light sensor, an ambient light sensor, a light sensor, or a sensor) that receives light through a partially opaque masking layer on a display cover layer, through a partially opaque masking layer on a display color filter layer, or through substantially all of the layers of a device display.

The display may include features that allow ambient light to pass through the display onto the solar cell ambient light sensor (e.g., opaque masking material that allows transmission of light of some wavelengths, openings such as microperforations in a layer of the display, etc.).

Storage and processing circuitry 400 samples voltages, electrical charges, or other electrical signals from solar cell ambient light sensors of sensor 38. Storage and processing circuitry 400 converts the sampled signals into ambient light intensities. Storage and processing circuitry 400 controls other aspects of the operation of device 10 using the converted ambient light intensities. For example, storage and processing circuitry can increase or decrease the display light from the device display based on the ambient light intensity.

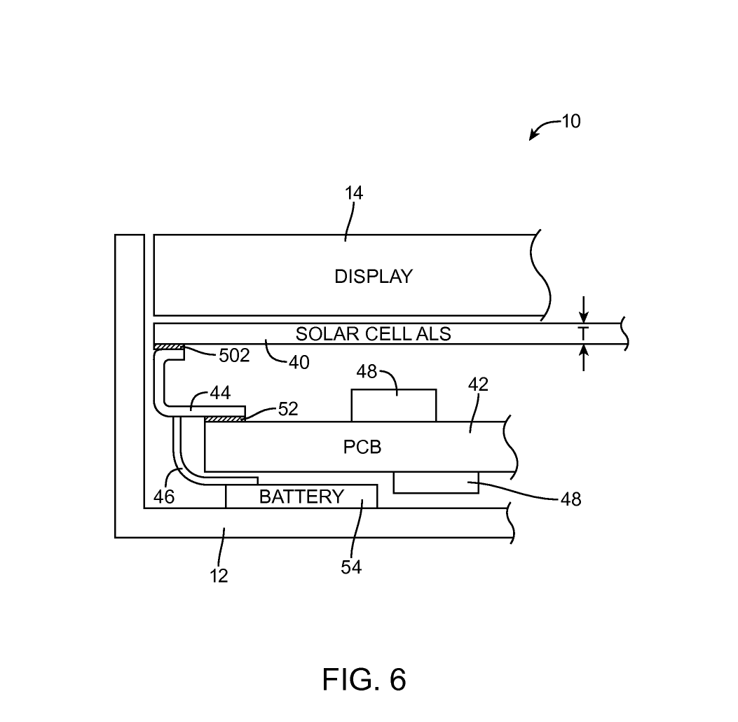

FIG. 6 is a cross-sectional view of a portion of device 10 showing a solar cell ambient light sensor 40 that is mounted behind a portion of display 14. Device 10 also includes a circuitry such as printed circuit board 42 and a flexible printed circuit 44 that electrically couples solar cell ambient light sensor 40 to printed circuit board (PCB) 42. Circuitry associated with printed circuit board 42 (e.g., internal circuitry, circuitry on a surface of PCB 42, and/or integrated circuitry such as circuit components 48 mounted to a surface of PCB 42) controls the operation of display 14 and ambient light sensor 40. PCB 42 and components 48 may, for example, form some or all of storage and processing circuitry 400 of FIG. 5.

Ambient light signals gathered using solar cell ambient light sensor (solar cell ALS) 40 are routed to printed circuit board 42 through flexible printed circuit 44. Flexible printed circuit 44 is attached to a portion of solar cell ALS 40 using electrical coupling material 502 (e.g., anisotropic conductive film (ACF), solder, or other electrically conductive adhesive material). An opposing end of flexible printed circuit 44 is attached to a portion of PCB 42 using electrical coupling material 52 (e.g., anisotropic conductive film (ACF), solder, or other electrically conductive adhesive materials, or mechanical connector structures).

In the example of FIG. 6, flexible printed circuit 44 includes an additional portion such as portion 46 that is coupled to battery 54. Voltages generated in solar cell ALS 40 that are not sampled for determination of ambient light intensities may be applied to battery 54, thereby charging battery 54.

Solar cell ALS 40 may be located near a portion of display 14 where emission of display light from display 14 is minimal so that the display light does not disrupt the operation of light sensor 40. However, this is merely illustrative. If desired, solar cell ALS 40 and/or a surface of display 14 may be provided with a light filtering or light reflecting film (e.g., a filter that prevents display light from display 14 from reaching light sensor 40 while allowing ambient light to reach light sensor 40 through the filter) or solar cell ALS 40 may be sampled during “off” periods of display illumination (e.g., between display pixel refreshes).

In one suitable example, flexible circuit 44 is a single layer flexible printed circuit. However, if desired, flexible circuit 44 may include additional printed circuit layers. Flexible circuit 44 may be attached to ambient light sensor 40 along an edge of display 14, along substantially all of an inner surface of display 14, or in other discrete locations behind portions of display 14.

Solar cell ambient light sensor 40 may has a thickness T. Thickness T may, for example, be less than 10 microns. Other examples of suitable thicknesses T for sensor 40 are less than 20 microns, less than 40 microns, less than 50 microns, between 5 microns and 10 microns, between 1 micron and 20 microns, or less than 250 microns.

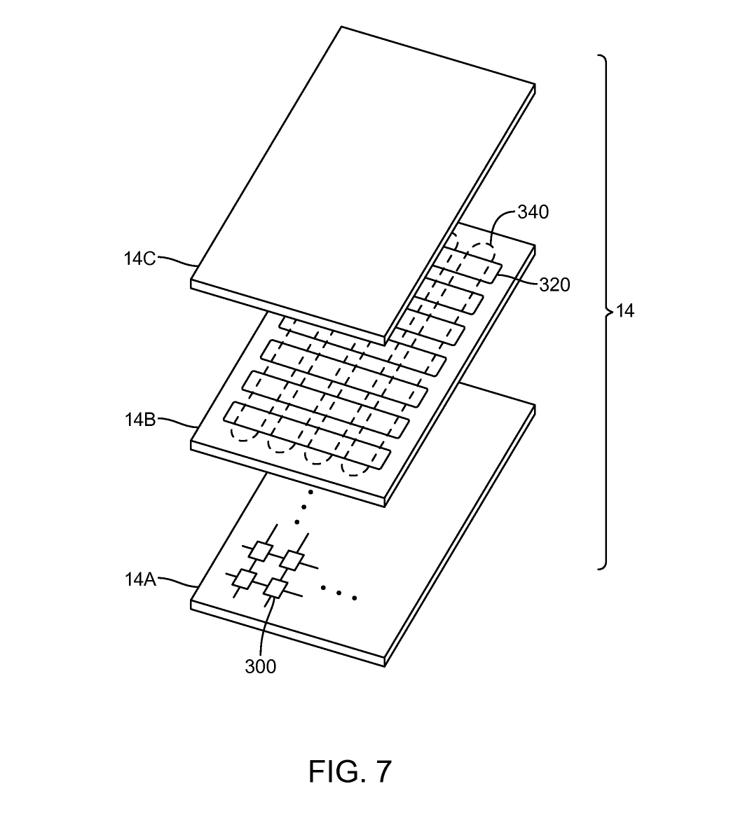

An exploded perspective view of an illustrative display of the type that may be used in the electronic device 10 is shown in FIG. 7. As shown in FIG. 7, display 14 includes display layers including light-generating layers 14A, touch-sensitive layer 14B, and cover layer 14C. Display 14 may also include other layers of material such as adhesive layers, optical films, or other suitable layers. Light-generating layers 14A may include image pixels 300 formed form light-emitting diodes (LEDs), organic LEDs (OLEDs), plasma cells, electronic ink elements, liquid crystal display (LCD) components, or other suitable image pixel structures compatible with flexible displays.

Touch-sensitive layer 14B may incorporate capacitive touch electrodes such as horizontal transparent electrodes 320 and vertical transparent electrodes 340. Touch-sensitive layer 14B may, in general, be configured to detect the location of one or more touches or near touches on touch-sensitive layer 14B based on capacitive, resistive, optical, acoustic, inductive, or mechanical measurements, or any phenomena that can be measured with respect to the occurrences of the one or more touches or near touches in proximity to touch sensitive layer 14B.

Software and/or hardware may be used to process the measurements of the detected touches to identify and track one or more gestures. A gesture may correspond to stationary or non-stationary, single or multiple, touches or near touches on touch-sensitive layer 14B. A gesture may be performed by moving one or more fingers or other objects in a particular manner on touch-sensitive layer 14B such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Cover layer 14C may be formed from plastic or glass (sometimes referred to as display cover glass) and may be flexible or rigid. If desired, the interior surface of peripheral portions of cover layer 14C may be provided with an opaque masking layer on such as black ink.

A solar cell ambient light sensor can be attached to one or more of display layers 14A, 14B, and/or 14C. The solar cell ambient light sensor may be configured to receive ambient light from the environment surrounding device 10 through cover layer 14C, through touch-sensitive layer 14B, and/or through one or more of light-generating layers 14A.

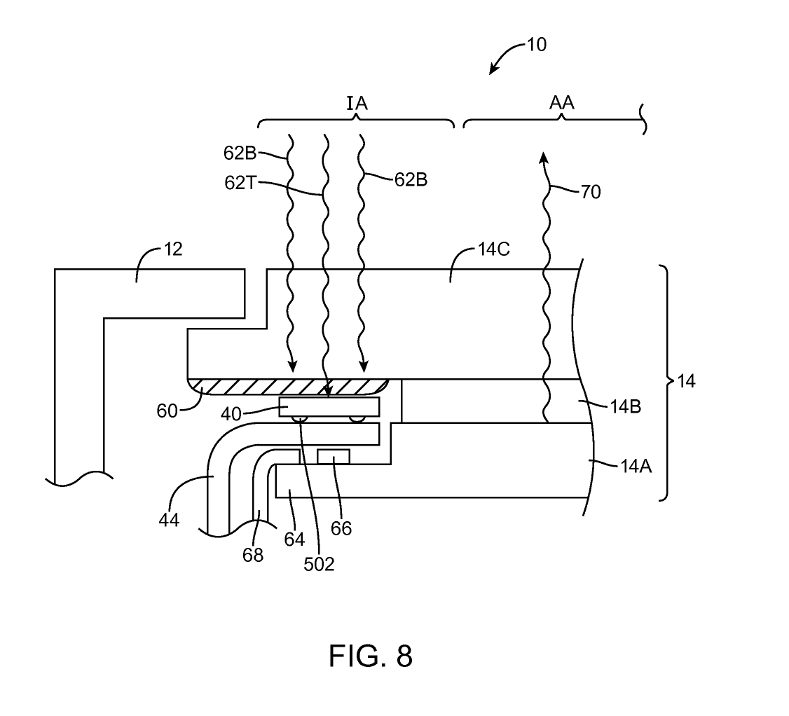

FIGS. 8, 9, and 10 show examples of possible locations at which a solar cell ambient light sensor can be attached to a device display.

In the example of FIG. 8, light sensor 40 is attached to an inner surface of cover layer 14C that is coated with masking material 60 in inactive portion IA of display 14. Masking material 60 is a partially opaque masking material such as a layer of black ink (e.g., a polymer filled with carbon black) or a layer of partially opaque metal that blocks light 62B from reaching sensor 40 while allowing light 62T to pass onto sensor 40. By blocking light 62B from reaching sensor 40, masking material 60 helps prevent a user from viewing sensor 40 through cover layer 14C. Blocked light 62B may have a different wavelength than transmitted light 62T or blocked light 62B may have substantially the same wavelength as transmitted light 62T.

Masking material 62 blocks more light than it passes. As examples, masking material 62 may allow at least two percent, at least 4 percent, at least 10 percent, at least 50 percent, between 1 percent and 10 percent, between 0.01 percent and 3 percent, between 0.1 percent and 0.3 percent, between 0.1 percent and 0.5 percent, or less than 1 percent of light at some or all wavelengths to pass through the masking material onto sensor 40.

As shown in FIG. 8, display layers 14A may include an extended portion 64. Extended portion 64 may, for example be a portion of a thin-film transistor layer of the display. Display control circuitry such as display driver integrated circuit 66 is mounted on extended portion 64. Device 10 may include an additional flexible circuit such as flexible printed circuit 68 coupled between extended portion 64 and, for example, PCB 42 (see, e.g., FIG. 6). Display light 70 is emitted from light-generating layers 14A in active region AA.

Device 10 may include a single light sensor 40 mounted at a discrete location on cover layer 14C, may include a single extended light sensor 40 that receives light through substantially all of cover layer 14C, may include a light sensor 40 that extends along one or more edges of cover layer 14C, or may include multiple light sensors 40 mounted at multiple locations on cover layer 14C.

As examples, light sensor 40 of FIG. 8 may be substantially smaller than the portion of cover layer 14C that is mounted in inactive area IA, light sensor 40 may have a size that is substantially the same as the portion of cover layer 14C that is mounted in inactive area IA, or device 10 may include multiple light sensors 40 on cover layer 14C.

In configurations in which device 10 includes multiple solar cell ambient light sensors 40 on cover layer 14C, light sensors 40 may be configured to receive light of different wavelengths (e.g., by providing each light sensor with a color filter or by forming each light sensor from materials that are sensitive to light of a given set of wavelengths) or light of a common wavelength. As examples, light sensor 40 may include two or more adjacent light sensors on cover layer 14C that receive light of a common color, two or more adjacent light sensors on cover layer 14C that receive light of different colors, two or more light sensors at separate locations on cover layer 14C that receive light of a common color, or two or more light sensors at separate locations on cover layer 14C that receive light of different colors.

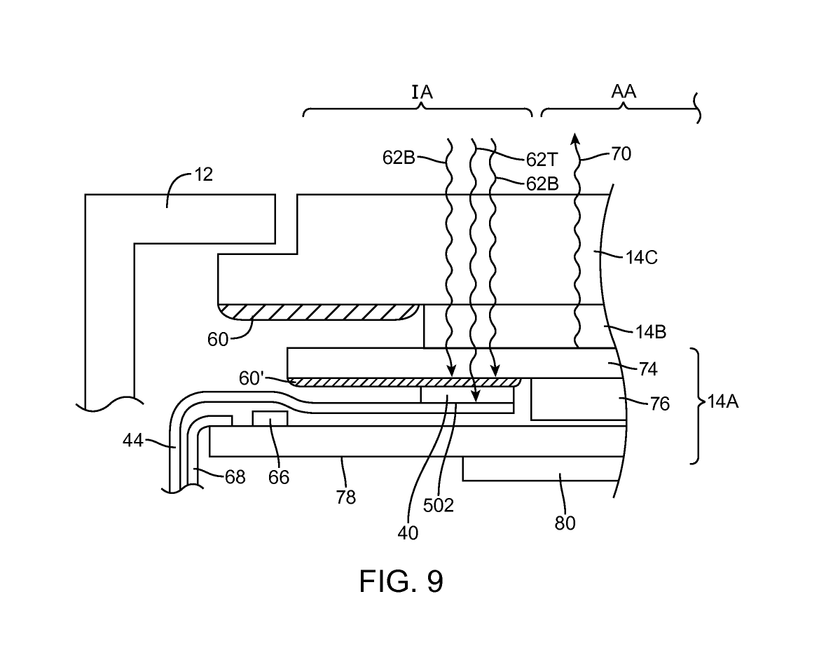

In the example of FIG. 9, light sensor 40 is attached to one of light-generating layers 14A that is coated with additional masking material 60′ in inactive portion IA of display 14. Additional masking material 60′ may have the same or different light blocking and light transmitting properties as masking material 60. Additional masking material 60′ is formed on an inner surface of an outermost layer 74 of light-generating layers 14A. Layer 74 may be a color filter layer for the display. Layer 74 may be formed from a transparent substrate such as a glass sheet with color filter elements formed on the substrate.

Light-generating layers 14A include additional layers such as thin-film transistor layer 78. Light-generating layers 14A may also include layers 76 formed above TFT layer 78 and layers 80 formed below TFT layer 78. Layers 76 and 80 may include light-polarizing layers, glass layers, layers of organic emissive material, encapsulation layers, substrate layers, liquid crystal layers, or other suitable display layers for generating display light for electronic device displays.

Device 10 may include a single light sensor 40 mounted at a discrete location on any of light generating layers 14A, may include a single extended light sensor 40 that receives light through substantially all of any of light generating layers 14A, may include a light sensor 40 that has a shape that is substantially the same as the shape of inactive area IA, may include multiple light sensors 40 mounted at multiple locations on a single one of light-generating layers 14A, or may include multiple light sensors 40 mounted at multiple locations on more than one of light-generating layers 14A.

As examples, light sensor 40 of FIG. 9 may be substantially smaller than the portion of layer 74 that is mounted in inactive area IA, light sensor 40 may have a size that is substantially the same as the portion of layer 74 that is mounted in inactive area IA, or device 10 may include multiple light sensors 40 on layer 74 and/or multiple light sensors 40 on other display layers (e.g., layer 14C, layer 14B, layer 76, layer 78 and/or layer 80).

In configurations in which device 10 includes multiple solar cell ambient light sensors 40, light sensors 40 may be configured to receive light of different wavelengths (e.g., by providing each light sensor with a color filter or by forming each light sensor from materials that are sensitive to light of a given set of wavelengths) or light of a common wavelength. As examples, light sensor 40 may include two or more adjacent light sensors that receive light of a common color, two or more adjacent light sensors that receive light of different colors, two or more light sensors at separate locations that receive light of a common color, or two or more light sensors at separate locations that receive light of different colors.

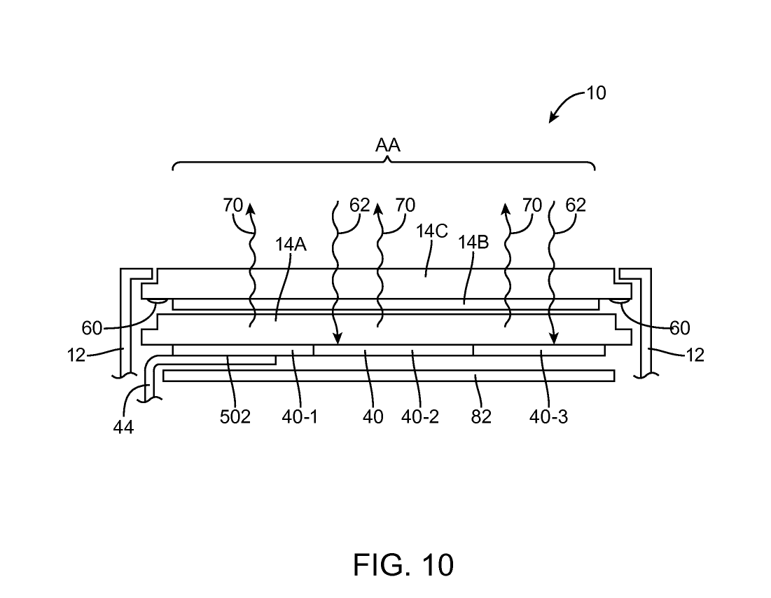

In the example of FIG. 10, light sensor 40 is attached to an interior surface of light-generating layers 14A in active area AA. Light sensor 40 of FIG. 10 extends across substantially all of active area AA. However, this is merely illustrative. If desired, one or more light sensors 40 may be attached to discrete portions or contiguous portions of the interior surface of light-generating layers 14A in active area AA.

Solar cell ambient light sensor 40 receives ambient light 62 through substantially all of the layers of display 14 (i.e., through cover layer 14C, through touch-sensitive layer 14B, and through light-generating layers 14A). Only a portion of ambient light 62 passes through display 14. Some of ambient light 62 (e.g., greater than 99.8 percent, greater than 99 percent, greater than 98 percent, or greater than 50 percent) is blocked by display 14 from reaching sensor 40.

Device 10 may also include internal support structures such as display chassis structure 82. Display chassis structure 82 may be formed from metal, plastic, other materials or combinations of materials. In one suitable example, structure 82 is metal. Structure 82 helps support display 14 within device 10.

A solar cell ambient light sensor such as sensor 40 of FIG. 10 can be formed from a single monolithic solar cell or from multiple segments or portions such as segments 40-1, 40-2, and 40-3. Segments 40-1, 40-2, and 40-3 may be separate solar cell ambient light sensors or may be separated portion of a common structure. Segments 40-1, 40-2, and 40-3 may be sensitive to light of a common set of wavelengths or may be sensitive to light of different respective sets of wavelengths. Each segment (e.g., segment 40-1, 40-2, or 40-3) may be tuned to generate a voltage in response to light of a certain wavelength (e.g., by providing each segment with an associated color filter or by forming each segment from materials that are sensitive to light of a given color). In the example of FIG. 10, segments 40-1, 40-2, and 40-3 are coupled to a common flexible printed circuit. However, if desired, each segment of solar cell ambient light sensor 40 may be coupled to a separate flexible printed circuit.

Control circuitry such as storage and processing circuitry 400 (FIG. 5) may use sampled ambient light signals (e.g., voltages) from one or more segments and/or one or more solar cell ambient light sensors for each determination of an ambient light intensity. For example, circuitry 400 may use signals from all segments of all sensors for a single ambient light intensity measurement or circuitry 400 may determine that one or more segments and/or one or more sensors is blocked (e.g., by a user's hand or head) and use sampled signals from only unblocked segments and/or sensors. Circuitry 400 may, for example, determine that a light sensor is blocked by determining that voltages on one or more ambient light sensors are substantial outliers with respect to voltages from other solar cell ambient light sensors.

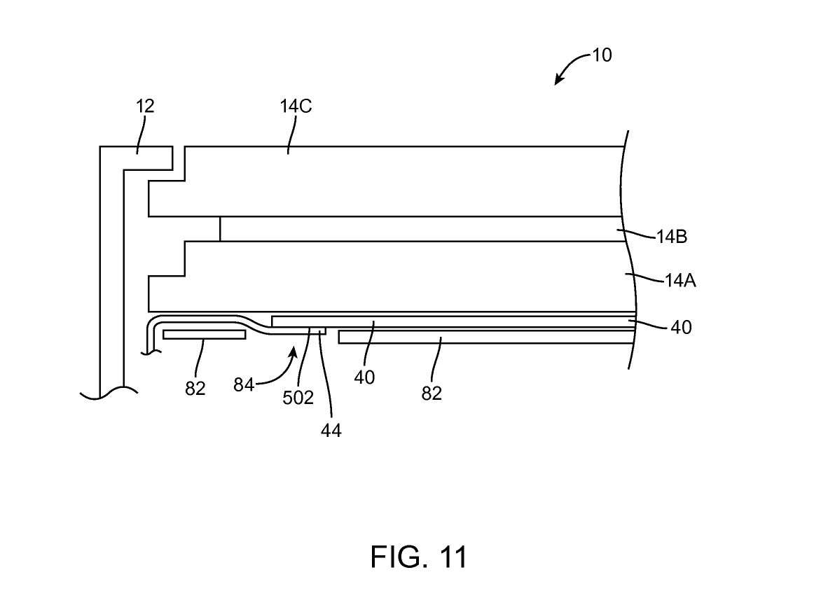

If desired, the thickness of display 14 may be further reduced by providing an opening in display chassis structure 82, as shown in FIG. 11.

In the example of FIG. 11, the portion of flexible printed circuit 44 that is coupled to solar cell ambient light sensor 40 is formed within opening 84 in display chassis structure 82. Opening 84 may be a localized opening such as a square shaped or rectangular shaped opening or opening 84 may run along some or all of an edge of structure 82.

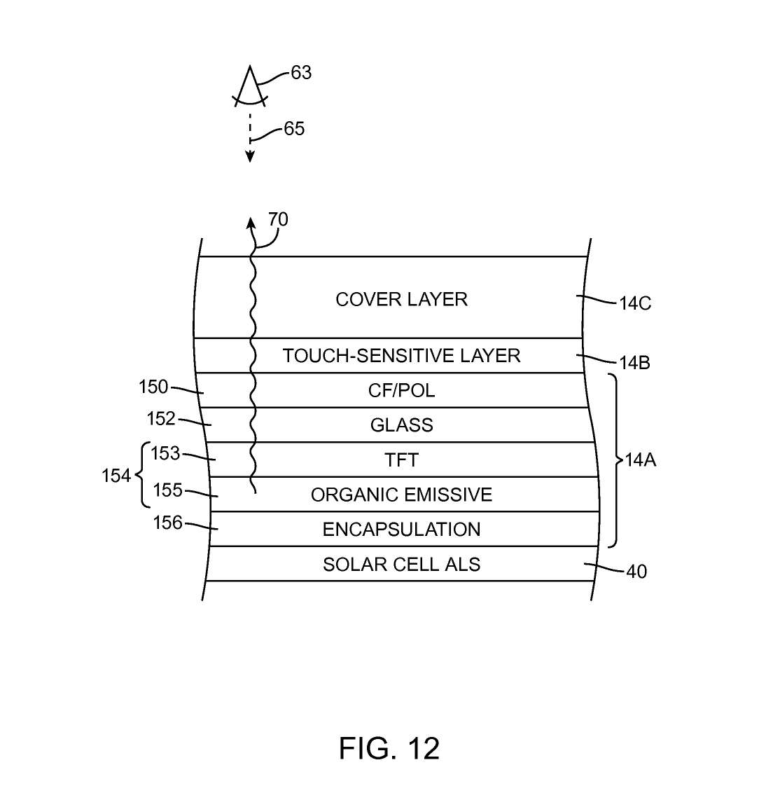

FIGS. 12, 13, and 14 show various configurations for light-generating layers 14A behind which solar cell ambient light sensor 40 may be mounted.

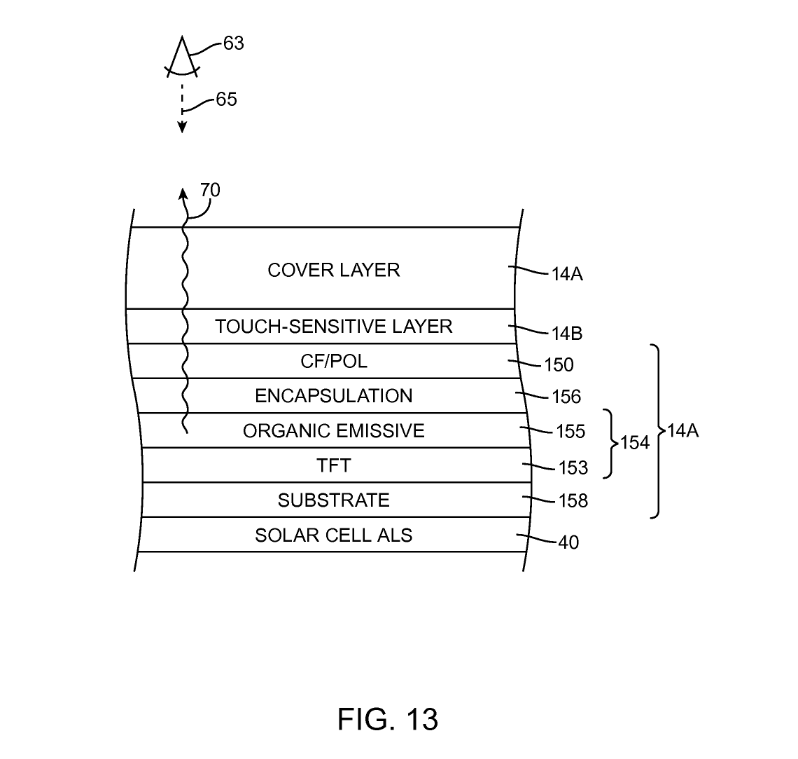

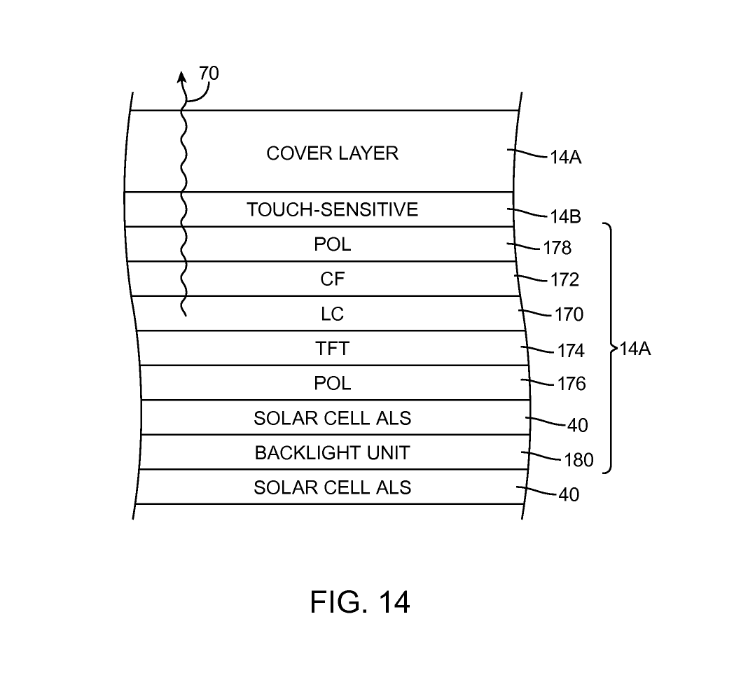

FIG. 12 is a cross-sectional view of a solar cell ambient light sensor that is mounted to light-generating layers 14A that are implemented as a bottom-emission organic light emitting diode (OLED) display. FIG. 13 is a cross-sectional view of a solar cell ambient light sensor that is mounted to light-generating layers 14A that are implemented as a top-emission organic light emitting diode (OLED) display. FIG. 14 is a cross-sectional view of a solar cell ambient light sensor that is mounted to light-generating layers 14A that are implemented as a liquid crystal display (LCD).

In a configuration for display 14 of the type shown in FIG. 12, light-generating layers 14A include a transparent substrate layer such as glass layer 152. A layer of organic light-emitting diode structures such as organic light-emitting diode layer 154 is formed on the underside of glass layer 152. An encapsulation layer such as encapsulation layer 156 is used to encapsulate organic light-emitting diode layer 154. Encapsulation layer 156 may be formed from a layer of metal foil, metal foil covered with plastic, other metal structures, a glass layer, a thin-film encapsulation layer formed from a material such as silicon nitride, a layered stack of alternating polymer and ceramic materials, or other suitable material for encapsulating organic light-emitting diode layer 154. Encapsulation layer 156 protects organic light-emitting diode layer 154 from environmental exposure by preventing water and oxygen from reaching organic emissive materials within organic light-emitting diode layer 154.

Organic-light-emitting diode layer 154 includes thin-film transistor (TFT) layer 153 and a layer of organic light-emitting material such as emissive layer 155. TFT layer 153 includes an array of thin-film transistors. The thin-film transistors may be formed from semiconductors such as amorphous silicon, polysilicon, or compound semiconductors (as examples). Organic emissive layer 155 may be formed from organic plastics such as polyfluorene or other organic emissive materials. Encapsulation layer 156 covers emissive layer 155 and, if desired, some or all of TFT layer 153.

During operation, signals are applied to the organic light-emitting diodes in layer 154 using the signal lines so that an image is created on display 14. Image light 70 from the organic light-emitting diode pixels in layer 154 is emitted upwards through transparent glass layer 152 for viewing in direction 65 by viewer 63. Color filter layer 150 may include a circular polarizer layer that suppress reflections from the metal signal lines in layer 154 that might otherwise be visible to viewer 63. Solar cell ambient light sensor 40 is attached to encapsulation layer 156 and receives light through cover layer 14C, touch-sensitive layer 14B, and light-generating layers 14A. However, this is merely illustrative. Sensor 40 may be attached to any of display layers 14C, 14B, 150, 152, 153, 156, and/or other suitable display layers.

In a configuration for display 14 of the type shown in FIG. 13, light-generating layers 14A include a substrate layer such as substrate layer 158. Substrate layer 158 may be a polyimide layer that is temporarily carried on a glass carrier during manufacturing or may be a layer formed from glass or other suitable substrate materials.

Organic light-emitting diode layer 154 is formed on the upper surface of substrate 158. An encapsulation layer such as encapsulation layer 156 encapsulates organic light-emitting diode layer 154. During operation, individually controlled pixels in organic light-emitting diode layer 154 generate display image light 70 for viewing in direction 65 by viewer 63. Color filter layer 150 may include a circular polarizer layer that suppresses reflections from metal signal lines in layer 154. Solar cell ambient light sensor 40 is attached to substrate 158 and receives light through cover layer 14C, touch-sensitive layer 14B, and light-generating layers 14A. However, this is merely illustrative. Sensor 40 may be attached to any of display layers 14C, 14B, 150, 153, 156, 158, and/or other suitable display layers.

In a configuration for display 14 of the type shown in FIG. 14, light-generating layers 14A include a layer of liquid crystal material such as liquid crystal (LC) layer 170. Liquid crystal layer 170 is formed between color filter layer 172 and thin-film transistor layer 174. Layers 172 and 174 may be formed on a transparent substrate such as a sheet of glass. Liquid crystal layer 170, color filter layer 172, and thin-film transistor layer 174 are sandwiched between light polarizing layers such as upper polarizer 178 and lower polarizer 176.

If desired, a solar cell ambient light sensor may be attached to lower polarizer layer 176 and receive light through cover layer 14C, touch-sensitive layer 14B, upper polarizer 178 color filter layer 172, liquid crystal layer 170, thin-film-transistor layer 174, and lower polarizer layer 176.

In this type of configuration, sensor 40 is interposed between polarizer 176 and backlight structures such as backlight unit 180 that generate backlight for the liquid crystal display. However, this is merely illustrative. If desired, a solar cell ambient light sensor 40 may be attached to an interior surface of backlight unit 180 and receive ambient light through cover layer 14C, touch-sensitive layer 14B, upper polarizer 178, color filter layer 172, liquid crystal layer 170, thin-film-transistor layer 174, and lower polarizer layer 176, and backlight unit 180. Backlight unit 180 or other portions of display 14 may, for example, include features that enhance the transmission of ambient light through display 14 to sensor 40. If desired, one or more solar cell ambient light sensors such as sensors 40 may be attached to any of cover layer 14C, touch-sensitive layer 14B, and/or any of layers 178, 172, 170, 174, 176, 180 or any other suitable display layers.

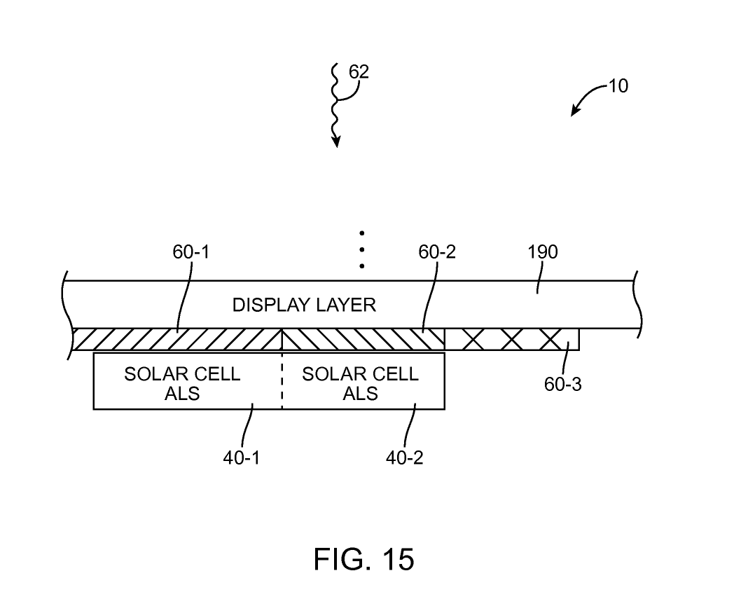

FIG. 15 is a cross-sectional view of a portion of device 10 showing how one or more solar cell ambient light sensors such as solar cell ambient light sensor segments 40-1 and 40-2 receive ambient light 62 through respective masking materials 60-1 and 60-2. Light sensors 40-1 and 40-2 may be segmented portions of a common light sensor or may be separate solar cell ambient light sensors.

Masking materials 60-1 and 60-2 may each block a respective portion of ambient light 62 from reaching sensors 40-1 and 40-2. Masking materials 60-1 and 60-2 may block light having a common set of wavelengths or material 60-1 may block light having different respective sets of wavelengths. For example, material 60-1 may transmit infrared light while blocking visible light and material 60-2 may transmit some visible light while blocking infrared light. Ambient light intensities for ambient light having various wavelengths can be combined (e.g., using storage and processing circuitry 400 of FIG. 5) to determine the electromagnetic spectrum of the ambient light source that produces ambient light 62. The color and/or intensity of display images generated using display 14 may be modified based on the detected spectrum and intensity of the ambient light.

Masking materials 60-1, 60-2 and, if desired, additional masking materials such as masking material 60-3 may be formed on a display layer such as display layer 190. Display layer 190 may, as examples, represent cover layer 14C or color filter layer 74.

The example of FIG. 15 in which sensors such as sensors 40-1 and 40-2 are configured to receive light of a given set of wavelengths by mounting the sensors behind respective light-filtering masking material such as masking material 60-1 and 60-2 is merely illustrative. If desired, each thin-film solar cell may itself be configured to respond (e.g., to generate a voltage that can be converted into an ambient light signal) to light of various sets of wavelengths (e.g., infrared wavelengths, visible (optical) wavelengths, ultraviolet wavelengths, etc.). For example, solar cell ambient light sensor 40-1 may be an infrared solar cell ambient light sensor that responds to infrared light and sensor 40-2 may be an optical solar cell ambient light sensor that responds to optical light.

Differences in ambient light levels at different wavelengths are used to determine a type of light source that is illuminating the device (e.g., indoor lighting, outdoor lighting, sunlight, incandescent lighting, fluorescent lighting, light-emitting diode lighting, etc.). The color and intensity of images formed using display 14 are modified based on the detected light source type and light intensity.

The foregoing is merely illustrative and various modifications can be made by those skilled in the art without departing from the scope and spirit of the described embodiments. The foregoing embodiments may be implemented individually or in any combination.

What is claimed is:

1. An electronic device, comprising:
a display;
an ambient light sensor attached to a portion of the display, wherein the ambient light sensor comprises at least one thin-film photovoltaic cell;
a flexible printed circuit having a first end that is attached to the at least one thin-film photovoltaic cell; and
control circuitry, wherein the flexible printed circuit has an opposing second end that is attached to the control circuitry.

2. The electronic device defined in claim 1 wherein the control circuitry is coupled to the display and wherein the control circuitry is configured to receive ambient light data from the ambient light sensor and to control the display using the ambient light data.

3. The electronic device defined in claim 2, further comprising a battery coupled to the ambient light sensor, wherein a voltage that accumulates on the at least one thin-film photovoltaic cell charges the battery.

4. The electronic device defined in claim 2, further comprising a housing, wherein a voltage that accumulates on the at least one thin-film photovoltaic cell is sampled by the control circuitry to generate the ambient light data.

5. The electronic device defined in claim 2 wherein the portion of the display comprises an active portion of the display that includes active display pixels and wherein the ambient light sensor receives light that passes through the active portion of the display.

6. The electronic device defined in claim 2 wherein the display includes an active area that generates display light for the display, wherein the display further includes a peripheral inactive area that surrounds the active area, and wherein the portion of the display comprises a portion of the inactive area of the display.

7. The electronic device defined in claim 1 wherein the at least one thin-film photovoltaic cell includes a substrate selected from the group consisting of: an amorphous silicon substrate, a cadmium telluride substrate, or a copper indium gallium deselenide substrate.

8. The electronic device defined in claim 1 wherein the ambient light sensor has a thickness and wherein the thickness is less than ten microns.

9. An electronic device, comprising:
a display having a plurality of display layers; and
a solar cell ambient light sensor attached to a selected one of the plurality of display layers, wherein the solar cell ambient light sensor receives ambient light through the selected one of the display layers.

10. The electronic device defined in claim 9, further comprising masking material on the selected one of the plurality of display layers, wherein the solar cell ambient light sensor receives the ambient light through the masking material.

11. The electronic device defined in claim 10 wherein the selected one of the plurality of display layers comprises a transparent cover layer.

12. The electronic device defined in claim 10 wherein the selected one of the plurality of display layers comprises a color filter layer.

13. The electronic device defined in claim 10 wherein the masking material blocks a portion of the ambient light from reaching the solar cell ambient light sensor and allows an additional portion of the ambient light to pass through the masking material onto the solar cell ambient light sensor.

14. The electronic device defined in claim 13 wherein the portion of the ambient light has a characteristic set of wavelengths and wherein the additional portion of the ambient light has an additional characteristic set of wavelengths that is different from characteristic set of wavelengths of the portion of the ambient light.

15. The electronic device defined in claim 14, further comprising at least one additional solar cell ambient light sensor.

16. The electronic device defined in claim 15 wherein the at least one additional solar cell ambient light sensor is configured to receive light having the additional characteristic set of wavelengths.

17. The electronic device defined in claim 15 wherein the at least one additional solar cell ambient light sensor is configured to receive light having a further additional characteristic set of wavelengths that is different from the additional characteristic set of wavelengths.

18. The electronic device defined in claim 15 wherein the at least one additional solar cell ambient light sensor is attached to the selected one of the plurality of display layers.

19. The electronic device defined in claim 15 wherein the at least one additional solar cell ambient light sensor is attached to an additional selected one of the plurality of display layers that is different from the selected one of the plurality of display layers.

20. An electronic device, comprising:
a display having an active area that emits display light and an inactive area; and
a photovoltaic light sensor attached to an interior surface of the display, wherein the photovoltaic light sensor receives light through the display and wherein the photovoltaic light sensor extends along the interior surface of the display in the entire active area of the display.

21. The electronic device defined in claim 20, further comprising control circuitry that operates the display and the photovoltaic light sensor.

22. The electronic device defined in claim 20 wherein the photovoltaic light sensor comprises a segmented photovoltaic light sensor and wherein each segment of the photovoltaic light sensor samples ambient light that passes through a corresponding region of the active area of the display.

23. The electronic device defined in claim 22 wherein each segment of the photovoltaic light sensor is configured to sample light of a different set of wavelengths.

24. The electronic device defined in claim 20 wherein the display comprises an organic light-emitting diode display.

25. The electronic device defined in claim 24 wherein the organic light-emitting diode display comprises a bottom-emission organic light-emitting diode display.

26. The electronic device defined in claim 24 wherein the organic light-emitting diode display comprises a top-emission organic light-emitting diode display.

27. The electronic device defined in claim 20 wherein the display comprises a liquid crystal display.
